(19) United States
(12) Patent Application Publication
(10) Pub. No.: US 2024/0373291 A1
(43) Pub. Date: Nov. 7, 2024

(54) METHOD AND APPARATUS FOR WIRELESS COMMUNICATION

(71) Applicant: INNOPEAK TECHNOLOGY, INC., Palo Alto, CA (US)

(72) Inventor: Tricci SO, Palo Alto, CA (US)

(21) Appl. No.: 18/774,085

(22) Filed: Jul. 16, 2024

Related U.S. Application Data
(63) Continuation of application No. PCT/US2023/011062, filed on Jan. 18, 2023.
(60) Provisional application No. 63/300,865, filed on Jan. 19, 2022.
(60) Provisional application No. 63/434,450, filed on Dec. 21, 2022.

(51) Int. Cl. H04W 28/08; H04W 28/02

(52) U.S. Cl. CPC H04W 28/0925; H04W 28/0268

(57) ABSTRACT

A method of wireless communication of a policy control function (PCF) entity is provided. The method may include receiving, by a communication interface, an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements. The method may include, obtaining, by at least one processor, a set of AGDT policies associated with the ASP from a unified data repository (UDR) entity. The method may include obtaining, by the at least one processor, a set of network performance analytics from a network data function analytics (NWDAF) entity based on the set of operational conditions indicated in the AGDT policy control create message from the ASP.

### CROSS-REFERENCE TO RELATED APPLICATIONS

This application is a Continuation Application of International Application No. PCT/US2023/011062 filed on Jan. 18, 2023, which claims the benefit of priorities to U.S. Provisional Application No. 63/300,865, entitled “QOS EXTENSIONS FOR BACKGROUND DATA TRANSFER SUPPORT OVER 5G SYSTEM BASED ON APPLICATION DATA QOS CHARACTERISTICS,” filed on Jan. 19, 2022, and U.S. Provisional Application No. 63/434,450, entitled “APPARATUS AND METHOD FOR APPLICATION GROUP DATA TRANSFER SUPPORT BASED ON GROUP QUALITY-OF-SERVICE POLICY TO ASSIST ARTIFICIAL INTELLIGENCE/MACHINE LEARNING/ML OPERATION(S),” filed on Dec. 21, 2022, all of which are incorporated herein by reference in their entireties.

### BACKGROUND

Embodiments of the present disclosure relate to apparatus and method for wireless communication.

Wireless communication systems are widely deployed to provide various telecommunication services such as telephony, video, data, messaging, and broadcasts. In cellular communication, such as the 4th-generation (4G) Long Term Evolution (LTE) and the 5th-generation (5G) New Radio (NR), the 3rd Generation Partnership Project (3GPP) defines various mechanisms for negotiating Application Group Data Transfer (AGDT) policies.

### SUMMARY

According to one aspect of the present disclosure, a method of wireless communication of a policy control function (PCF) entity is provided. The method may include receiving, by a communication interface, an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements. The method may include, obtaining, by at least one processor, a set of AGDT policies associated with the ASP from a unified data repository (UDR) entity. The method may include obtaining, by the at least one processor, a set of network performance analytics from a network data function analytics (NWDAF) entity based on the set of operational conditions indicated in the AGDT policy control create message from the ASP. The method may include identifying, by the at least one processor, one or more available AGDT policies from the set of AGDT policies based on the set of operational conditions and the set of network performance analytics. The method may include communicating, by the at least one processor, one or more available AGDT policies to the AF entity associated with the ASP.

According to another aspect of the present disclosure, an apparatus for wireless communication of a PCF is provided. The apparatus may include at least one processor. The apparatus may include memory having instructions stored thereon, which when executed by the at least one processor cause the at least one processor to perform receiving an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements. The apparatus may include memory having instructions stored thereon, which when executed by the at least one processor causes the at least one processor to perform, obtaining a set of AGDT policies associated with the ASP from a unified data repository (UDR) entity. The apparatus may include memory having instructions stored thereon, which when executed by the at least one processor cause the at least one processor to perform obtaining a set of network performance analytics from a network data function analytics (NWDAF) entity based on the set of operational conditions indicated in the AGDT policy control create message from the ASP. The apparatus may include memory having instructions stored thereon, which when executed by the at least one processor causes the at least one processor to perform identifying one or more available AGDT policies from the set of AGDT policies based on the set of operational conditions and the set of network performance analytics. The apparatus may include memory having instructions stored thereon, which when executed by the at least one processor causes the at least one processor to perform communicating one or more available AGDT policies to the AF entity associated with the ASP.

According to still another aspect of the present disclosure, a method of wireless communication of a first network element is provided. The method may include receiving, by a communication interface, an application function (AF) session create request from an AF associated with an application service provider (ASP) at a time when a data transfer window is about to start, the AF session create request including an application group data transfer (AGDT) reference identifier (ID) associated with an AGDT session for an artificial intelligence or machine learning data transfer to one or more user equipments (UEs) and one or more quality-of-service (QOS) parameters associated with the AGDT session. The method may include performing, by at least one processor, an authorization procedure associated with the AGDT session. The method may include, in response to authorization success, sending, by the communication interface, a policy authorization create request that includes at least one user equipment (UE) address and individual quality-of-service (QOS) parameters associated with the AGDT session to a second network entity. The method may include sending, by the communication interface, a policy authorization subscribe message to the second network entity to subscribe to notifications related to resource allocation status related to the AGDT session. The method may include receiving, by the communication interface, an indication of applying of an AGDT policy for an associated protocol data unit (PDU) session from the second network entity based on information from a third network entity. The method may include indicating, by the at least one processor, the applying of the AGDT policy for the AGDT session to the AF associated with the ASP.

According to yet another aspect of the present disclosure, a method of wireless communication of a first network element is provided. The method may include receiving, by a communication interface, an application function (AF) session create request from an AF associated with an application service provider (ASP) at a time when a data transfer window is about to start, the AF session create request including an application group data transfer (AGDT) reference identifier (ID) associated with an AGDT session for an artificial intelligence or machine learning data transfer to one or more user equipments (UEs) and one or more quality-of-service (QOS) parameters associated with the AGDT session. The method may include performing, by at least one processor, an authorization procedure associated with the AGDT session. The method may include, in response to authorization success, sending, by the communication interface, a policy authorization delete request that includes at least one user equipment (UE) address and individual quality-of-service (QOS) parameters associated with the AGDT session to a second network entity. The method may include sending, by the communication interface, a policy authorization subscribe message to the second network entity to subscribe to notifications related to resource allocation status related to the AGDT session. The method may include receiving, by the communication interface, an indication of revoking of an AGDT policy for an associated protocol data unit (PDU) session from the second network entity based on information from a third network entity. The method may include indicating, by the at least one processor, the revoking of the AGDT policy for the AGDT session to the AF associated with the ASP.

These illustrative embodiments are mentioned not to limit or define the present disclosure, but to provide examples to aid understanding thereof. Additional embodiments are discussed in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates an exemplary wireless network, according to some embodiments of the present disclosure.

FIG. 2 illustrates a block diagram of an exemplary node, according to some embodiments of the present disclosure.

FIG. 3 illustrates an exemplary service-based wireless communication system architecture, according to some embodiments of the present disclosure.

FIG. 4 illustrates a conceptual flow diagram of a first exemplary data flow of an exemplary AGDT transfer policies negotiation procedure, according to some embodiments of the present disclosure.

FIG. 5 illustrates a conceptual flow diagram of an exemplary AGDT policy applying/removing procedure, according to some embodiments of the present disclosure.

FIG. 6 illustrates a conceptual flow diagram of an exemplary AGDT warning notification procedure, according to some embodiments of the present disclosure.

FIG. 7 illustrates a flow chart of a first exemplary method of wireless communication, according to some embodiments of the present disclosure.

FIG. 8 illustrates a flow chart of a second exemplary method of wireless communication, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of wireless communication systems will now be described with reference to various apparatus and methods. These apparatus and methods will be described in the following detailed description and illustrated in the accompanying drawings by various blocks, modules, units, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various wireless communication networks, such as code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, wireless local area network (WLAN) system, and other networks. The terms “network” and “system” are often used interchangeably. A CDMA network may implement a radio access technology (RAT), such as Universal Terrestrial Radio Access (UTRA), evolved UTRA (E-UTRA), CDMA 2000, etc. A TDMA network may implement a RAT, such as the Global System for Mobile Communications (GSM). An OFDMA network may implement a RAT, such as LTE or NR. A WLAN system may implement a RAT, such as Wi-Fi. The techniques described herein may be used for the wireless networks and RATs mentioned above, as well as other wireless networks and RATs.

The present disclosure specifies service procedures to enable the application function (AF) entity of a 5G New Radio (NR) network to negotiate a viable time window for the planned application data transfer associated with quality-of-service (QOS) requirements and operational conditions via the support of the network exposure function (NEF) entity.

Application group data transfer (AGDT) policies are defined for a specific application service provider (ASP), which include the one or more group QoS profiles corresponding to the respective desired time windows, the maximum number of user equipments (UEs) to be supported, the optional list of target UEs, the optional network area information, and the optional request for notification if the AF accepts the AGDT policy to be re-negotiated using the AGDT warning notification procedure.

The network performance analytics or data network (DN) performance analytics for the network data analytics function (NWDAF) entity, as described in various sections of the 3rd generation partnership project (3GPP) standard, will be subscribed by the policy control function (PCF) entity to assist its decision to derive the AGDT policies for the selected time window(s).

One or more negotiated AGDT policies could be provided by PCF to AF via NEF together with the AGDT reference identifier (ID) provided by the AF. The AF will then select one of them and inform the PCF about the selected AGDT policy, which will then be stored in the unified data repository (UDR) to be applied to the AF session when requested by the AF. Prior to the start of the desired time window for the planned application data transfer, the AF requests the PCF to apply the selected AGDT policy to the selected target UEs' protocol data unit (PDU) sessions. The PCF will then determine the appropriate policy and charging control (PCC) rules according to the negotiated AGDT policy for the corresponding PDU session. Additional details of the various embodiments of the present disclosure are provided below.

In order to enable the mobile network operators (MNOs) to assist ASPs in transporting their application traffic (e.g., AI/ML traffic) in a more controlled time-table under the considerations of the availability of network resources, various AGDT mechanisms are provided in the present disclosure to support pre-negotiation between the AF and the 5G system to agree on the list of negotiated time windows with their respective specified group QoS policies that meet the QoS requirements of the specific group application data (e.g., AI/ML traffic) transfer requested by the AF. After the successful negotiation of the list of time windows to support the specified group application data transfer, the AF will then select one of those time windows to activate the group application data transfer according to the AGDT policy that has been negotiated.

Further, in order to enable higher assurance for the 5G system to be able to grant the desired time windows for the AF's request for the group application data (e.g., AI/ML traffic) transfer with the required QOS parameters, extensions of the existing network performance analytics and the DN performance analytics from NWDAF to project the QoS performance (e.g., packet delay buffer, packet loss rate, and packet traffic rate) in order to derive the list of the desired time windows with their respective QoS performance. Such analytics reports could be useful to assist the PCF decision to derive the appropriate PCC rules for the corresponding PDU sessions requested by the AF to support the specific group application data (e.g., AI/ML traffic) transfer.

Finally, if the 5G system detects the possible system performance degradation that is no longer able to support the application group data transfer, the AF will be notified for such an event.

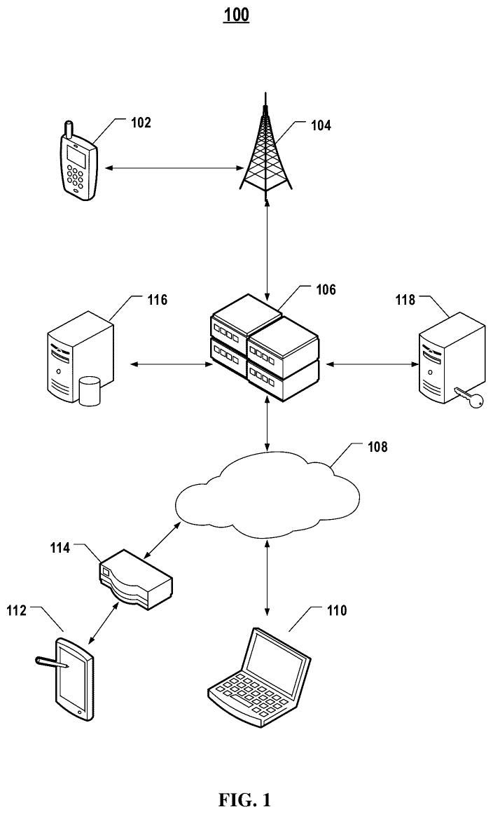

FIG. 1 illustrates an exemplary wireless network 100, in which some aspects of the present disclosure may be implemented, according to some embodiments of the present disclosure. As shown in FIG. 1, wireless network 100 may include a network of nodes, such as a user equipment (UE) 102, an access node 104, and a core network element 106. UE 102 may be any terminal device, such as, a mobile phone, a desktop computer, a laptop computer, a tablet, a vehicle computer, a gaming console, a printer, a positioning device, a wearable electronic device, a smart sensor, an unmanned aerial vehicle (UAV, e.g., a drone or other uncrewed flying device), or any other device capable of receiving, processing, and transmitting information, such as any member of a vehicle to everything (V2X) network, a cluster network, a smart grid node, or an Internet-of-Things (IoT) node. It is understood that UE 102 is illustrated as a mobile phone simply by way of illustration and not by way of limitation.

Access node 104 (also referred to herein as “access network” or “radio access network (RAN)”) may be a device that communicates with UE 102, such as a wireless access point, a base station (BS), a Node B, an enhanced Node B (eNodeB or eNB), a next-generation NodeB (gNodeB or gNB), a cluster master node, or the like. Access node 104 may have a wired connection to UE 102, a wireless connection to UE 102, or any combination thereof. Access node 104 may be connected to UE 102 by multiple connections, and UE 102 may be connected to other access nodes in addition to access node 104. Access node 104 may also be connected to other user equipments. When configured as a gNB, access node 104 may operate in millimeter wave (mmW) frequencies and/or near mmW frequencies in communication with the UE 102. When access node 104 operates in mmW or near mmW frequencies, the access node 104 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW or near mmW radio frequency band have extremely high path loss and a short range. The mmW base station may utilize beamforming with UE 102 to compensate for the extremely high path loss and short range. It is understood that access node 104 is illustrated by a radio tower by way of illustration and not by way of limitation.

Access nodes 104, which are collectively referred to as E-UTRAN in the evolved packet core network (EPC) and as NG-RAN in the 5G core network (5GC), interface with the EPC and 5GC through dedicated backhaul links (e.g., SI interface). In addition to other functions, access node 104 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. Access nodes 104 may communicate directly or indirectly (e.g., through the 5GC) with each other over backhaul links (e.g., X2 interface). The backhaul links may be wired or wireless.

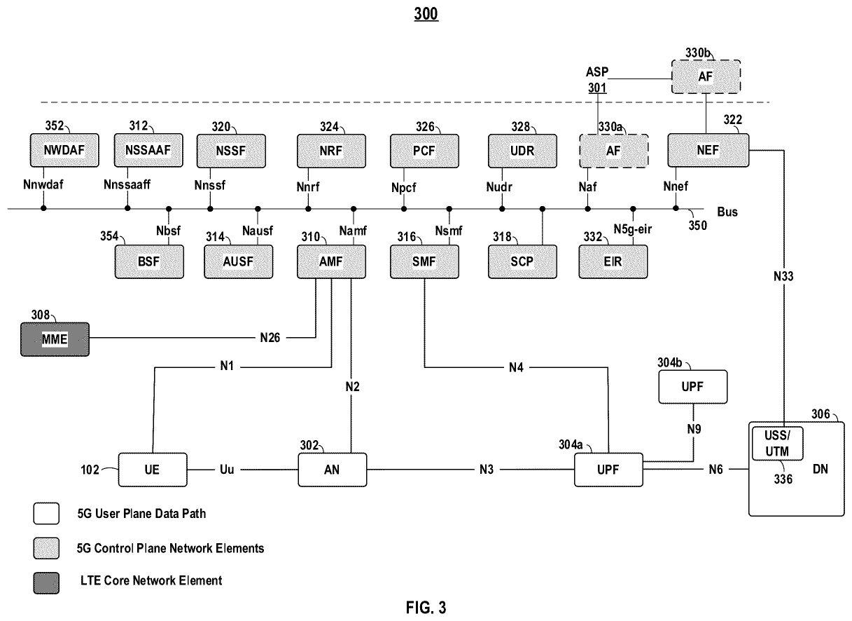

Core network element 106 may serve access node 104 and UE 102 to provide core network services. In some embodiments, core network element 106 includes a mobility management entity (MME), which may be part of an evolved packet core (EPC) for the LTE system. In some embodiments, core network element 106 may include an access and mobility management function (AMF), a session management function (SMF), or a user plane function (UPF), of a 5G core network (5GC) for the NR system. The AMF may be in communication with a unified data management (UDM). The AMF is the control node that processes the signaling between the UE 102 and the 5GC. Generally, the AMF provides QoS flow and session management. All user Internet protocol (IP) packets are transferred through the UPF. The UPF provides UE IP address allocation as well as other functions. The UPF is connected to the IP services. The IP services may include the Internet, an intranet, an IP multimedia subsystem (IMS), a PS streaming service, and/or other IP services. It is understood that core network element 106 is shown as a set of rack-mounted servers by way of illustration and not by way of limitation. Additional examples of core network element 106 are depicted in FIGS. 3, 4, 5, and 6. In some embodiments, core network element 106 may include one or more network elements.

Core network element 106 may connect with a large network, such as the Internet 108, or another Internet Protocol (IP) network, to communicate packet data over any distance. In this way, data from UE 102 may be communicated to other user equipments connected to other access points, including, for example, a computer 110 connected to Internet 108, for example, using a wired connection or a wireless connection, or to a tablet 112 wirelessly connected to Internet 108 via a router 114. Thus, computer 110 and tablet 112 provide additional examples of possible user equipments, and router 114 provides an example of another possible access node.

A generic example of a rack-mounted server is provided as an illustration of core network element 106. However, there may be multiple elements in the core network including database servers, such as a database 116, and security and authentication servers, such as an authentication server 118. Database 116 may, for example, manage data related to user subscription to network services. A home location register (HLR) is an example of a standardized database of subscriber information for a cellular network. Likewise, authentication server 118 may handle authentication of users, sessions, and so on. In the NR system, an authentication server function (AUSF) device may be the entity to perform user equipment authentication. In some embodiments, a single server rack may handle multiple such functions, such that the connections between core network element 106, authentication server 118, and database 116, may be local connections within a single rack.

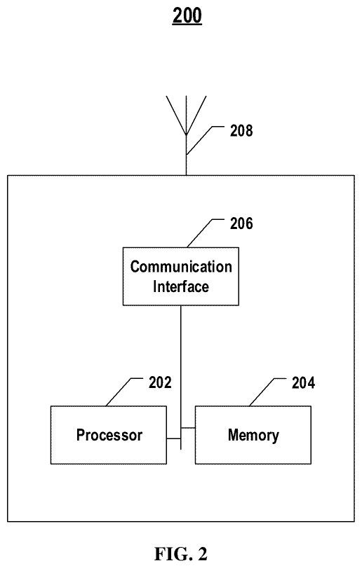

Each element in FIG. 1 may be considered a node of wireless network 100. More detail regarding the possible implementation of a node is provided by way of example in the description of a node 200 in FIG. 2. Node 200 may be configured as UE 102, access node 104, or core network element 106 in FIG. 1. Similarly, node 200 may also be configured as computer 110, router 114, tablet 112, database 116, or authentication server 118 in FIG. 1. As shown in FIG. 2, node 200 may include a processor 202, a memory 204, and a communication interface 206. These components are shown as connected to one another by a bus, but other connection types are also permitted. When node 200 is UE 102, additional components may also be included, such as a user interface (UI), sensors, and the like. Similarly, node 200 may be implemented as a blade in a server system when node 200 is configured as core network element 106. Other implementations are also possible.

Communication interface 206 may include any suitable device for sending and/or receiving data, such as transceivers. Node 200 may include one or more communication interfaces, although only one communication interface 206 is shown for simplicity of illustration. An antenna 208 is shown as a possible communication mechanism for node 200. Multiple antennas and/or arrays of antennas may be utilized for receiving multiple spatially multiplex data streams. Additionally, examples of node 200 may communicate using wired techniques rather than (or in addition to) wireless techniques. For example, access node 104 may communicate wirelessly to UE 102 and may communicate by a wired connection (for example, by optical or coaxial cable) to core network element 106. Other communication hardware, such as a network interface card (NIC), may be included as well.

As shown in FIG. 2, node 200 may include processor 202. Although only one processor is shown, it is understood that multiple processors can be included. Processor 202 may include microprocessors, microcontroller units (MCUs), digital signal processors (DSPs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Processor 202 may be a hardware device having one or more processing cores. Processor 202 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

As shown in FIG. 2, node 200 may also include memory 204. Although only one memory is shown, it is understood that multiple memories can be included. Memory 204 can broadly include both memory and storage. For example, memory 204 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 202. Broadly, memory 204 may be embodied by any computer-readable medium, such as a non-transitory computer-readable medium.

Processor 202, memory 204, and communication interface 206 may be implemented in various forms in node 200 for performing wireless communication functions. In some embodiments, processor 202, memory 204, and communication interface 206 of node 200 are implemented (e.g., integrated) on one or more system-on-chips (SoCs). In one example, processor 202 and memory 204 may be integrated on an application processor (AP) SoC (sometimes known as a “host,” referred to herein as a “host chip”) that handles application processing in an operating system (OS) environment, including generating raw data to be transmitted. In another example, processor 202 and memory 204 may be integrated on a baseband processor (BP) SoC (sometimes known as a “modem,” referred to herein as a “baseband chip”) that converts the raw data, e.g., from the host chip, to signals that can be used to modulate the carrier frequency for transmission, and vice versa, which can run a real-time operating system (RTOS). In still another example, processor 202 and communication interface 206 (and memory 204 in some cases) may be integrated on an RF SoC (sometimes known as a “transceiver,” referred to herein as an “RF chip”) that transmits and receives RF signals with antenna 208. It is understood that in some examples, some or all of the host chip, baseband chip, and RF chip may be integrated as a single SoC. For example, a baseband chip and an RF chip may be integrated into a single SoC that manages all the radio functions for cellular communication.

FIG. 3 illustrates an exemplary service-based architecture 300 of a wireless communication system (referred to hereinafter as “system architecture 300), according to some embodiments of the present disclosure. System architecture 300 may include various network elements, such as 5G control plane (CP) network elements (also referred to herein as “network functions (NFs)) and LTE core network element(s) (e.g., MME 308), for example. System architecture 300 may also include access network 302 (e.g., including access node 104 of FIG. 1) and UE 102, among others.

System architecture 300 may be designed to support network function (NF) virtualization and software-defined networking. Moreover, system architecture 300 may leverage service-based interactions between different NFs. User plane (UP) functions may be separated from CP functions, as shown in FIG. 3. The separation of UP functions and CP functions in system architecture 300 may enable independent scalability, evolution, and flexible deployments in either a centralized or distributed manner. The UP data path of system architecture 300 may include, e.g., UE 102, access network 302 (e.g., access node 104), one or more user plane function(s) (UPF) 304a, 304b, and a data network (DN) 306. The CP data path includes various NFs. These NFs may include one or more of, e.g., AMF 310, network slice-specific authentication and authorization function (NSSAAF) 312, AUSF 314, SMF 316, service communication proxy (SCP) 318, network slice selection function (NSSF) 320, NEF 322, network repository function (NRF) 324, PCF 326, UDR 328, AF 330, network data analytics function (NWDAF) 352, binding support function (BSF) 354, and equipment identity register (EIR) 332. Each of the NFs may be coupled to a bus 350 via service-based interfaces (SIBs) labeled as, e.g., Namf, Nsmf, Nudr, etc. Where appropriate, system architecture 300 may include point-to-point connections labeled as, e.g., N1, N2, N3, etc. The functions of each of the NFs are described below. A third-party entity, such as USS/unified threat management (UTM) 336, may be located in DN 306 and maintain subscription services. These subscription services may include uncrewed aerial services. USS/UTM 336 may include a USS network of one or more USS(s). Thus, as used herein, the term USS may refer to a USS network that includes one or more USS(s).

In addition to those responsibilities described above in connection with FIG. 1, AMF 310 may perform registration management, connection management, reachability management, access authentication, and/or access authorization, just to name a few. NSSAAF 312 may support and initiate NSSAA operations. As mentioned above, AUSF 314 may perform user equipment authentication. SMF 316 may perform session establishment, session modification, session release, maintain a tunnel between UPF 304a and access node 104 of access network 302, user equipment IP address allocation and management, dynamic host configuration protocol (DHCP) functions (for both server and client), downlink data notification, and support for proxy-call session control function (P-CSCF) discovery for IMS services, for example. SCP 318 may enable indirect communication between various NFs by routing information from an originating NF to a destination NF. NSSF 320 may support various functions associated with network slicing. NRF 324 may enable NFs to disclose the service list offered by other NFs.

Consistent with the scope of the present disclosure, PCF 326 may provide policy rules to certain NFs (e.g., AF 330 and AMF 310), and access subscription information relevant for policy decisions in UDR 328, for example. UDR 328 may provide a unified database for storing application, subscription, authentication, service authorization, policy data, session binding, application state information, etc.

Consistent with the scope of the present disclosure, AFs 330a, 330b may provide application services to the subscribed user. For example, AFs 330a, 330b may be associated with ASPs 301 to provide various application services, such as, an artificial intelligence (AI) or machine learning (ML) service, a video streaming service, an uncrewed aerial service, just to name a few. If AF 330 is trusted (i.e., trusted AF 330a), trusted AF 330a may interact directly with other NFs. Otherwise, if AF 330 is untrusted (i.e., untrusted AF 330b, e.g., a third-party entity), then untrusted AF 330b may interact with other NFs via NEF 322 (as shown in FIG. 3).

Consistent with the scope of the present disclosure, NEF 322 may support the exposure of network functions capabilities of NFs to external NFs, such as third-party entities, e.g., USS/UTM 336. External exposure may include monitoring capability, provisioning capability, policy/charging capability, and analytics reporting capability. The monitoring capability may include the monitoring of certain events for UE 102 and making such monitoring event information available for external exposure via NEF 322. The provisioning capability may include allowing an external party to provide information that can be used by UE 102. The policy/charging capability may include handling QoS and charging policy for UE 102 based on the request from an external party.

Consistent with the scope of the present disclosure, NWDAF 352 may collect data from UEs, NFs, and operations, administration, and maintenance (OAM) systems, etc., that can be used for analytics by subscription or request model and perform network analytics based on the collected data. NWDAF 352 may help automate and deliver network optimization, cost efficiency, and resource management to meet service-level agreement (SLA) and QoS requirements. For example, NWDAF 352 may streamline the way data is produced and consumed in 5G NR to enable closed-loop network operations and automated assurance for superior customer experiences.

Consistent with the scope of the present disclosure, BSF 354 may allow PCF 326 to register, update, and remove the binding information from it, and allows NFs to discover PCF 326. BSF 354 may store the binding information for a certain PDU session and discover PCF 326 according to the binding information. BSF 354 may also act as a diameter proxy agent or diameter redirect agent to receive requests targeting an IP address of a UE to PCF 326.

Consistent with the scope of the present disclosure, extensions to existing services of NWDAF 352 are provided to support performance statistics and predictions for the QoS performance to assist PCF 326 in deriving PCC rules to support ADGT service. For example, AGDT service is provided to allow AF 330 to request a list of desired time windows to support group data transmission for a group of UEs 102 via the service operation “Nnef_AGDTNegotiation_Create” as described below in detail. The AGDT service may support primary and alternative QoS profiles (e.g., packet delay budget (PDB), packet loss ratio (PLR), etc.), and each profile may correspond to their respective desired time windows to support the specific application service (e.g., AI/ML) data transfer requested by AF 330.

In some embodiments, the QoS parameters for AGDT policy and applying to the primary and alternative QoS profiles requested by AF 330 include, but not limited to, packet delay for uplink/downlink (UL/DL) per UE 102 per time window, maximum packet loss rate for UL/DL per UE 102 per time window, and guaranteed and maximum bitrate for UL/DL per UE 102 per time window. It is understood that the guaranteed and maximum bitrate may also be referred to as the minimum bitrate.

In some embodiments, to assist PCF 326, the network performance or DN performance analytics is enhanced to report the prediction of the QoS performance. For example, the enhancement may involve adding the input parameters to the network performance analytics and DN performance analytics, so that the extended network performance or DN performance analytics can derive the set of the QoS performance statistic and predictions corresponding to a specified time window to assist the decision of PCF 326 for the PCC rules. It is understood that in some examples, PCF 326 should refer to either network performance analytics or DN performance analytics, but not both.

According to some aspect of the present disclosure, for network performance analytics, NWDAF 352 may be required to subscribe to the “Performance Data from AF” similar to clause 6.4.2 or clause 6.14.2 in 3GPP Technical Specification (TS) 23.288 either directly for trusted AFs 330a by invoking “Naf_EventExposure_Subscribe” service operation (e.g., Event ID=Performance Data, Event Filter information=Area of Interest, Application ID) as defined in 3GPP TS 23.502, or indirectly for untrusted AFs 330b via NEF 322 by invoking “Nnef_EventExposure_Subscribe” service operation (e.g., Event ID=Performance Data, Event Filter information=Area of Interest, Application ID) where NEF 322 can translate the area of interest into geographic zone ID(s) in order to derive the output performance statistic and prediction indicators for the following exemplary QoS parameters corresponding to the specific time window: maximum/average packet delay for UL/DL per UE 102 per time window, maximum/average packet loss rate for UL/DL per UE 102 per time window, and maximum/minimum/average traffic rate for UL/DL per UE 102 per time window. For example, the above-mentioned QoS parameters may be provided by NWDAF 352 for user plane performance in the form of statistics or predictions to a service consumer during the validity target time period.

In some embodiments, in order to enable NWDAF 352 to derive the set of the QoS performance statistic and predictions corresponding to the specified time period, the following performance data is collected from AF 330 as described in TABLE I below, as the input data of NWDAF 352.

TABLE I
Performance Data from AF

| Information | Source | Description |
|---|---|---|
| UE identifier | AF | IP address of the UE at the time the |
| | | measurements was made. |
| UE location | AF | The location of the UE when the performance |
| | | measurement was made. |
| Application ID | AF | To identify the service and support analytics |
| | | per type of service (the desired level of |
| | | service). |
| IP filter information | AF | Identify a service flow of the UE for the |
| | | application. |
| Locations of Application | AF/NEF | Locations of application represented by a list |
| | | of DNAI(s). The NEF may map the AF- |
| | | Service-Identifier information to a list of |
| | | DNAI(s) when the DNAI(s) being used by the |
| | | application are statically defined. |
| Application Server Instance | AF/NEF | The IP address/FQDN of the Application |
| address | | Server that the UE had a communication |
| | | session when the measurement was made. |
| Performance Data | AF | The performance associated with the |
| | | communication session of the UE with an |
| | | Application Server that includes: |
| | | Average/Maximum Packet Delay, |
| | | Average/Maximum Loss Rate and |
| | | Average/Minimum/Maximum Throughput. |
| Timestamp | AF | A time stamp associated to the Performance |
| | | Data provided by the AF. |

For example, NWDAF 352 may subscribe to network data as defined in clause 6.4.2 of 3GPP TS 23.288, data may be collected from OAM as described in clause 6.4.2 of 3GPP TS 23.288 by using the services provided by OAM as described in clause 6.2.3 of 3GPP TS 23.288, and the event filters for the service data collection from SMF 316, AMF 310, and AF 330 may be defined in 3GPP TS 23.502. For example, the timestamps may be provided by each NF to allow correlation of QoS and traffic key performance indicators (KPIs), and the clock reference may be able to know the accuracy of the time and correlate the time series of the data retrieved from each NF.

In some embodiments, NWDAF 352 is able to provide both statistics and predictions on network performance as output analytics, as shown in TABLE II and TABLE III below.

TABLE II
Network Performance Statistics

| Information | Description |
|---|---|
| List of network performance | Observed statistics during the Analytics target period |
| information (1 . . . max) | |
| > Area subset | TA or Cell ID within the requested area of interest as |
| | defined in clause 6.6.1 |
| > Analytics target period subset | Time window within the requested Analytics target |
| | period as defined in clause 6.6.1. |
| > gNB status information (NOTE 1) | Average ratio of gNBs that have been up and running |
| | during the entire Analytics target period in the area |
| | subset |
| > gNB resource usage (NOTE 1) | Average usage of assigned resources (CPU, memory, |
| | disk) |
| > Number of UEs (NOTE 1) | Average number of UEs observed in the area subset |
| > Communication performance | Average ratio of successful setup of PDU Sessions |
| (NOTE 1) | |
| > Mobility performance (NOTE 1) | Average ratio of successful handover |
| Application ID | Identifies the application for which analytics |
| | information is provided. |
| S-NSSAI | Identifies the Network Slice for which analytics |
| | information is provided. See NOTE 1. |
| DNN | Identifies the data network name (e.g., “internet”) for |
| | which analytics information is provided. See NOTE 1. |
| > Performance | Performance indicators. |
| >> Average Traffic rate | Average traffic rate observed for UEs communicating |
| (NOTE 2) | with the application. |
| >> Maximum Traffic rate | Maximum traffic rate observed for UEs communicating |
| (NOTE 2) | with the application. |
| >> Minimum Traffic rate | Minimum traffic rate observed for UEs communicating |
| (NOTE 2) | with the application. |
| >> Average Packet Delay | Average packet delay observed for UEs communicating |
| (NOTE 2) | with the application. |
| >> Maximum Packet Delay | Maximum packet delay for observed for UEs |
| (NOTE 2) | communicating with the application. |
| >> Average Packet Loss Rate | Average packet loss observed for UEs communicating |
| (NOTE 2) | with the application. |
| > Spatial Validity Condition | Area where the Network performance analytics applies. |
| > Temporal Validity Condition | Validity period for the Network performance analytics. |

(NOTE 1):
Analytics subset that can be used in “list of analytics subsets that are requested” and “Preferred level of accuracy per analytics subset.”
(NOTE 2):
Analytics subset that can be used in “list of analytics subsets that are requested,” “Preferred level of accuracy per analytics subset,” and “Reporting Thresholds.”

TABLE III
Network Performance Predictions

| Information | Description |
|---|---|
| List of network performance | Predicted analytics during the Analytics target period |
| information (1 . . . max) | |
| > Area subset | TA or Cell ID within the requested area of interest as |
| | defined in clause 6.6.1 |
| > Analytics target period subset | Time window within the requested Analytics target |
| | period as defined in clause 6.6.1. |
| > gNB status information (NOTE 1) | Average ratio of gNBs that will be up and running |
| | during the entire Analytics target period in the area |
| | subset |
| > gNB resource usage (NOTE 1) | Average usage of assigned resources (CPU, memory, |
| | disk) (average, peak) |
| > Number of UEs (NOTE 1) | Average number of UEs predicted in the area subset |
| > Communication performance | Average ratio of successful setup of PDU Sessions |
| (NOTE 1) | |
| > Mobility performance (NOTE 1) | Average ratio of successful handover |
| > Confidence | Confidence of this prediction |
| > Performance | Performance indicators. |
| >> Average Traffic rate | Average traffic rate observed for UEs communicating |
| (NOTE 2) | with the application. |
| >> Maximum Traffic rate | Maximum traffic rate observed for UEs communicating |
| (NOTE 2) | with the application. |
| >> Minimum Traffic rate | Minimum traffic rate observed for UEs communicating |
| (NOTE 2) | with the application. |
| >> Average Packet Delay | Average packet delay observed for UEs communicating |
| (NOTE 2) | with the application. |
| >> Maximum Packet Delay | Maximum packet delay for observed for UEs |
| (NOTE 2) | communicating with the application. |
| >> Average Packet Loss Rate | Average packet loss observed for UEs communicating |
| (NOTE 2) | with the application. |
| > Spatial Validity Condition | Area where the Network performance analytics applies. |
| > Temporal Validity Condition | Validity period for the Network performance analytics. |

(NOTE 1):
Analytics subset that can be used in “list of analytics subsets that are requested” and “Preferred level of accuracy per analytics subset.”
(NOTE 2):
Analytics subset that can be used in “list of analytics subsets that are requested,” “Preferred level of accuracy per analytics subset,” and “Reporting Thresholds.”

According to some aspects of the present disclosure, for DN performance analytics, NWDAF 352 may enhance DN performance analytics according to clause 6.14 of 3GPP TS 23.288 to support performance static and prediction for the above-described set of QoS parameters per specific time window (i.e., through the temporal validity condition).

In some embodiments, in order to enable NWDAF 352 to derive the set of the QoS parameters per specific time window, the following performance data is collected from AF 330, as described in TABLE IV below, as the input data of NWDAF 352.

TABLE IV
Performance Data from AF

| Information | Source | Description |
|---|---|---|
| UE identifier | AF | IP address of the UE at the time the |
| | | measurements was made. |
| UE location | AF | The location of the UE when the performance |
| | | measurement was made. |
| Application ID | AF | To identify the service and support analytics |
| | | per type of service (the desired level of |
| | | service). |
| IP filter information | AF | Identify a service flow of the UE for the |
| | | application. |
| Locations of Application | AF/NEF | Locations of application represented by a list |
| | | of DNAI(s). The NEF may map the AF- |
| | | Service-Identifier information to a list of |
| | | DNAI(s) when the DNAI(s) being used by the |
| | | application are statically defined. |
| Application Server Instance | AF/NEF | The IP address/FQDN of the Application |
| address | | Server that the UE had a communication |
| | | session when the measurement was made. |
| Performance Data | AF | The performance associated with the |
| | | communication session of the UE with an |
| | | Application Server that includes: Average |
| | | Packet Delay, Average Loss Rate and |
| | | Average, Minimum and Maximum |
| | | Throughput during the validity period. |
| Timestamp | AF | A time stamp associated to the Performance |
| | | Data provided by the AF. |

For example, NWDAF 352 may subscribe to network data as defined in clause 6.4.2 of 3GPP TS 23.288, data may be collected by SMF 316 as described in clause 6.4.2 of 3GPP TS 23.288 or collected from OAM as described in clause 6.4.2 of 3GPP TS 23.288 by using the services provided by OAM as described in clause 6.2.3 of 3GPP TS 23.288, and the event filters for the service data collection from SMF 316, AMF 310, and AF 330 may be defined in 3GPP TS 23.502. For example, the timestamps may be provided by each NF to allow correlation of QoS and traffic key performance indicators (KPIs), and the clock reference may be able to know the accuracy of the time and correlate the time series of the data retrieved from each NF.

In some embodiments, NWDAF 352 is able to provide both statistics and predictions on DN service performance as output analytics, as shown in TABLE V and TABLE VI below.

TABLE V
DN Service Performance Statistics

| Information | Description |
|---|---|
| Application ID | Identifies the application for which analytics information |
| | is provided. |
| S-NSSAI | Identifies the Network Slice for which analytics |
| | information is provided. See note 1. |
| DNN | Identifies the data network name (e.g., “internet”) for |
| | which analytics information is provided. See NOTE 1. |
| DN performance (0-x) | List of DN performances for the application. |
| > Application Server Instance | Identifies the Application Server Instance (IP |
| Address | address/FQDN of the Application Server). |
| > Serving anchor UPF info | The UPF ID/address/FQDN information for the involved |
| | anchor UPF. See NOTE 1. |
| > DNAI | Identifier of a user plane access to one or more DN(s) |
| | where applications are deployed as defined in |
| | TS 23.501 [2]. |
| > Performance | Performance indicators. |
| >> Average Traffic rate | Average traffic rate observed for UEs communicating |
| (NOTE 2) | with the application. |
| >> Minimum Traffic rate | Minimum traffic rate observed for UEs communicating |
| (NOTE 2) | with the application. |
| >> Maximum Traffic rate | Maximum traffic rate observed for UEs communicating |
| (NOTE 2) | with the application. |
| >> Average Packet Delay | Average packet delay observed for UEs communicating |
| (NOTE 2) | with the application. |
| >> Maximum Packet Delay | Maximum packet delay for observed for UEs |
| (NOTE 2) | communicating with the application. |
| >> Average Packet Loss | Average packet loss observed for UEs communicating |
| Rate (NOTE 2) | with the application. |
| > Spatial Validity Condition | Area where the DN performance analytics applies. |
| > Temporal Validity | Validity period for the DN performance analytics. |
| Condition | |

(NOTE 1):
The item “DNN,” “S-NSSAI,” and “Serving anchor UPF info” shall not be included if the consumer NF is an untrusted AF.
(NOTE 2):
Analytics subset that can be used in “list of analytics subsets that are requested,” “Preferred level of accuracy per analytics subset,” and “Reporting Thresholds.”

TABLE VI
DN Service Performance Predictions

| Information | Description |
|---|---|
| Application ID | Identifies the application for which analytics information |
| | is provided. |
| S-NSSAI | Identifies the Network Slice for which analytics |
| | information is provided. See NOTE 1. |
| DNN | Identifies the data network name (e.g., “internet”) for |
| | which analytics information is provided. See NOTE 1. |
| DN performance (0-x) | List of DN performance for the application. |
| > Application Server Instance | Identifies the Application Server Instance (IP |
| Address | address/FQDN of the Application Server). |
| > Serving anchor UPF info | The UPF ID/address/FQDN information for the involved |
| | anchor UPF. See NOTE 1. |
| > DNAI | Identifier of a user plane access to one or more DN(s) |
| | where applications are deployed as defined in |
| | TS 23.501 [2]. |
| > Performance | Performance indicators |
| >> Average Traffic rate | Average traffic rate predicted for UEs communicating |
| (NOTE 2) | with the application. |
| >> Minimum Traffic rate | Minimum traffic rate predicted for UEs communicating |
| (NOTE 2) | with the application. |
| >> Maximum Traffic rate | Maximum traffic rate predicted for UEs communicating |
| (NOTE 2) | with the application. |
| >> Average Packet Delay | Average packet delay predicted for UEs communicating |
| (NOTE 2) | with the application. |
| >> Maximum Packet Delay | Maximum packet delay for predicted for UEs |
| (NOTE 2) | communicating with the application. |
| >> Average Packet Loss | Average packet loss predicted for UEs communicating |
| Rate (NOTE 2) | with the application. |
| > Spatial Validity Condition | Area where the DN performance analytics applies. |
| > Temporal Validity | Validity period for the DN performance analytics. |
| Condition | |
| > Confidence | Confidence of this prediction. |

(NOTE 1):
The item “DNN,” “S-NSSAI,” and “Serving anchor UPF info” shall not be included if the consumer NF is an untrusted AF.
(NOTE 2):
Analytics subset that can be used in “list of analytics subsets that are requested,” “Preferred level of accuracy per analytics subset,” and “Reporting Thresholds.”

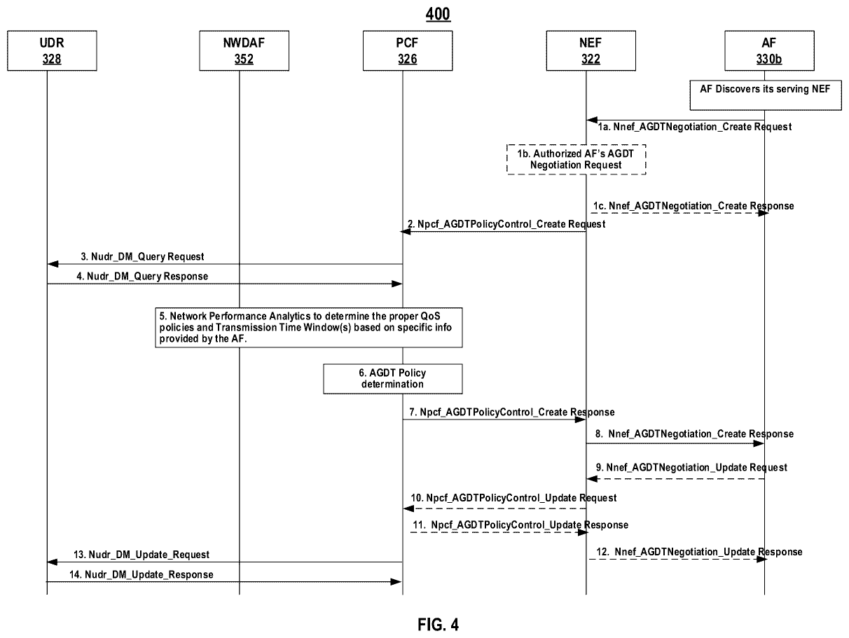

According to some aspects of the present disclosure, an AGDT transfer policy negotiation procedure is provided for planned AGDT to negotiate viable time window with specific QoS requirements and operational conditions between AF 330 and PCF 326 with the support of NEF 322, NWDAF 352, and UDR 328. For example, FIG. 4 illustrates a conceptual flow diagram 400 of an exemplary AGDT transfer policy negotiation procedure, according to some embodiments of the present disclosure. The AGDT transfer policy negotiation procedure described in FIG. 4 can provide AGDT with specific group QoS parameters, which include one or more of the following functionalities: AF 330b requests the 5G core via NEF 322 to establish the group QoS policy to support the specific application group data transfer. AF 330b notifies the 5G core via NEF 322 to identify the specific group QoS policy to support the target application group data transfer.

Prior to identifying the set of target UEs to support the planned application data transfer during the specified time window, AF 330b associated with an ASP (e.g., AF 330b may be located at the server of an ASP, e.g., such as Tesla) initiates requests to NEF 322 (an example of NEF) with the required set of parameters (e.g., QoS parameters or target area-of-interest (AOI) etc.) to (re) negotiate AGDT policies that should have been pre-provisioned or negotiated previously and are stored in UDR 328. In some examples, the application data may be AI/ML data.

Still referring to FIG. 4, prior to the transport of the application data, the AF 330b may negotiate with the 5G core for the AGDT policies to provide assistance for its application data transfer. AF 330b may discover its serving NEF 322.

AF 330b may invoke (at operation 1a) the Nnef_AGDTNegotiation_Create Request service operation (AGDT negotiation request). The AGDT negotiation request may indicate that the consumer requests an application group data transfer with group QoS requirements. The inputs of the AGDT negotiation request may include one or more of ASP ID, the number of UEs, volume per UE, the list of desired time windows, QOS reference or individual QoS parameters, and optionally the list of UE IDs, network area Information, alternative service requirements, and request for notification. For example, the request for notification may be an indication that an AGDT warning notification should be sent to AF 330b. The outputs of the AGDT negotiation request may include the AGDT Reference ID and one or more application group data transfer with the corresponding group QoS policies.

In some examples, if a “flock” scenario applies to the group of selected UEs which are to participate in this AGDT transfer window, the AGDT policy may automatically take into account the “flock” scenario into consideration by specifying the minimum guaranteed QoS requirements. Flock QoS support may be determined by AF 330b based on its internal logic or policy. For example, AF 330b may determine the flock QoS based on the UEs and the network input data and the group application data transfer trigger conditions.

NEF 322 may authenticate (at operation 1b) AF 330b and authorize the AGDT request from AF 330b. If the authentication/authorization of the AGDT negotiation request from AF 330b is failed, NEF 322 may respond (at operation 1c) to the AGDT negotiation request from AF 330b through the Nnef_AGDTNegotiation_Create Response service operation with the failure result, and the following operations may be skipped.

When authorization success is determined, based on the AGDT negotiation request from AF 330b, NEF 322 may perform some service translation on the information provided by AF 330b (e.g., QoS reference or geographical information, etc.) based on the local policy and invoke (at operation 2) the Npcf_AGDTPolicyControl_Create request service operation (AGDT policy request). The AGDT policy request may create the application group data transfer with a specific group QoS policy. The inputs of the AGDT policy request may include one or more of ASP ID, the number of UEs, volume per UE, the list of desired time windows, the QoS reference or individual QoS parameters, and optionally the list of UE IDs request, the alternative service requirements, network area information, S-NSSAI, DNN, and request for notification). The outputs of the AGDT policy request may include one or more application group data transfer with specific group QoS policies and AGDT reference ID. NEF 322 may send (at operation 2) the AGDT policy request to PCF 326 to authorize the creation of the policy regarding the AGDT. For example, PCF 326 may be an H-PCF, which is a system PCF responsible for system policies. If PCF 326 was provided with the request for notification, then PCF 326 will send an AGDT warning notification to AF 330b as described below in detail to enable PCF 326 to notify AF 330b that the network performance in the area of interest goes below the criteria set by the operator.

PCF 326 may query (at operation 3) UDR 328 to retrieve all existing AGDT policies for the corresponding ASP (associated with AF 330b) using Nudr_DM_Query Request (UDR request), which may include policy data, and AGDT data transfer with QoS service operation.

In response to the UDR request, UDR 328 may provide (at operation 4) all the stored AGDT policies and corresponding related information (e.g., the number of UEs, volume per UE, the list of desired time windows, the QoS parameters, and optionally the alternative QoS parameters) to PCF 326 in the form of, for example, Nudr_DM_Query Response.

Based on information provided by AF 330b and other available information, PCF 326 subscribes (at operation 5) to the NWDAF 352 to request the network performance or DN performance analytics, e.g., either the guaranteed bitrate (GBR) or non-GBR traffic type, as described above in detail with respect to NWDAF 352. NWDAF 352 may report (at operation 5) PCF 326 of the requested analytics report for one or more recommended desired time windows.

By referring to the outcome of the analytics reports, PCF 326 may determine (at operation 6) one or more AGDT policies. The AGDT policies may include the QoS parameters (e.g., PDB, PLR etc.) for each desired time window and the network Area information as initially requested by AF 330b.

PCF 326 may send (at operation 7) one or more AGDT policies to NEF 322 using Npcf_AGDTPolicyControl_Create Response including the AGDT reference ID. NEF 322 may send (at operation 8) the Nnef_AGDTNegotiation_Create Response to AF 330b to provide one or more AGDT policies together with the AGDT reference ID.

If more than one AGDT policy is provided to AF 330b, AF 330b may select one of the AGDT policies and notify (at operation 9) NEF 322 of the selected AGDT policy via the Nnef_AGDTNegotiated_Update service operation (AGDT update request) having the AGDT reference ID. The AGDT update request requests the selected application group data transfer with specified group QoS policy to be set. Here, AF 330b may maintain the AGDT reference ID and the selected AGDT policy for future interaction with PCF 326. If NEF 322 receives only one AGDT policy from PCF 326, operations 10 and 11 described below in connection with FIG. 4 may be executed, and the flow may proceed to operation 12 directly. Otherwise, the flow proceeds to operation 10 when more than one AGDT policy is indicated to AF 330b.

If NEF 322 receives only one AGDT policy from PCF 326, NEF 322 may notify (at operation 10) PCF 326 of the AGDT policy selected by AF 330b using the Npcf_AGDTPolicyControl_Update Request service operation, which updates the application group data transfer with specific group QoS policy to PCF 326. PCF 326 may respond (at operation 11) with the Npcf_AGDTPolicyControl_Update Response. NEF 322 may respond (at operation 12) to the AGDT update request from AF 330b through the Nnef_AGDTNegotiation_Update Response.

PCF 326 may maintain the AGDT reference ID together with the new AGDT policy in UDR 328 by invoking (at operation 13) the Nudr_DM_Update Request service operation, which may include the AGDT reference ID, policy Data, and AGDT data Transfer with QoS. UDR 328 may acknowledge (at operation 14) receipt of the Nudr_DM_Update Request with the Nudr_DM_Update Response to PCF 326 as its acknowledgment.

After the AGDT policy negotiation, if AF 330b decides to select (not shown in FIG. 4) an alternative AGDT policy (e.g., data rate reduction, relaxing delay constraints of planned and event-driven traffic etc.), AF 330b may trigger this procedure to request PCF 326 via the support of NEF 322 to revise the AGDT policy.

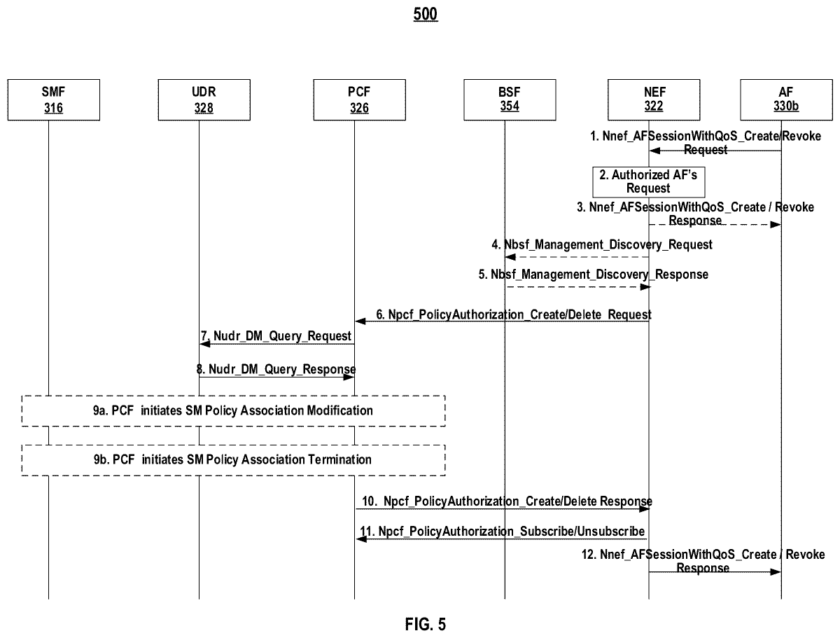

FIG. 5 illustrates a conceptual flow diagram 500 of an exemplary AGDT policy applying/removing procedure, according to some embodiments of the present disclosure. In some embodiments, when AF 330b applies the AGDT transfer policy to an existing PDU session for individual UE, AF 330b may invoke the Nnef_AFsessionWithQoS_Create Request and Npcf_PolicyAuthorization_Create Request service operations to PCF 326 via the support of NEF 322. AF 330b may also provide the AGDT reference ID together with the AF session information to PCF 326 that serves the PDU session. NEF 322 may authorize the AF request. Once NEF 322 authorizes the AF request, PCF 326 may retrieve the corresponding AGDT transfer policy from UDR 328 to derive the PCC rule for the PDU session according to the negotiated AGDT policy as described above.

In some embodiments, if AF 330b decides to remove the AGDT policy for an existing PDU session, AF 330b may invoke the Nnef_AFsessionWithQoS_Revoke Request and Npcf_PolicyAuthorization_Delete request service operations to PCF 326 via the support of NEF 322. AF 330b may also provide the AGDT reference ID together with the AF session information to PCF 326 that serves the PDU session. NEF 322 may authorize the AF request before removing the PDU session.

As shown in FIG. 5, when AF 330b decides to apply/delete the AGDT policy of a given application data (e.g., AI/ML traffic) transfer for a PDU session, AF 330b may, at the time the data transfer window is about to start, provide (at operation 1), for the target UE, the AGDT reference ID together with the AF session information to PCF 326 that serves the PDU session (e.g., via the N5 interface). NEF 322 may authorize (at operation 2) the AF request. If the authorization is not granted, NEF 322 may reply (at operation 3) AF 330b with a result value indicating that the authorization failed and skip the following operations.

AF 330b may attempt to discover (at operation 4) the UE's serving PCF 326 via NEF 322 with the support (at operation 5) of BSF 354 by using the UE's ID information. Then, NEF 322 may interact with PCF 326 by triggering (at operation 6) the Npcf_PolicyAuthorization_Create/Delete Request service operation and provide information including one or more of the target UE address, AF ID, flow description(s), the individual QoS parameters, QOS Reference, and the alternative service requirements for the PDU session to which the AF session is bound. In some embodiments, NEF 322 may send a Npcf_PolicyAuthorization_Subscribe message to PCF 326 to subscribe to notifications of resource allocation status and may subscribe to other events using various techniques.

PCF 326 may query (at operation 7) UDR 328 to retrieve all existing AGDT policies for the corresponding ASP using the Nudr_DM_Query Request service operation, which may include information associated with policy data, planned data transfer with QoS, etc.

If AF's 330b request (at operation 1) is to apply AGDT policy for a PDU session, PCF 326 may update (at operation 9a) SMF 316 with corresponding new PCC rule(s) with PCF 326 initiated session management (SM) policy association modification procedures.

AF 330b may request to revoke (at operation 1) AGDT policy for a PDU session. PCF 326 may notify SMF 316 for the removal of the SM policy control association with PCF 326 by invoking the SM policy association termination procedure using various techniques.

Then, PCF 326 may respond (at operation 10) to NEF 322 for the completion of applying or revoking the AGDT policy for the target PDU session.

NEF 322 may send (at operation 11) the Npcf_PolicyAuthorization_Subscribe/Unsubscribe message to PCF 326 to subscribe/unsubscribe to notifications of resource allocation status. NEF 322 may respond (at operation 12) to AF 330b for the completion of applying or revoking the AGDT policy for the target PDU session.

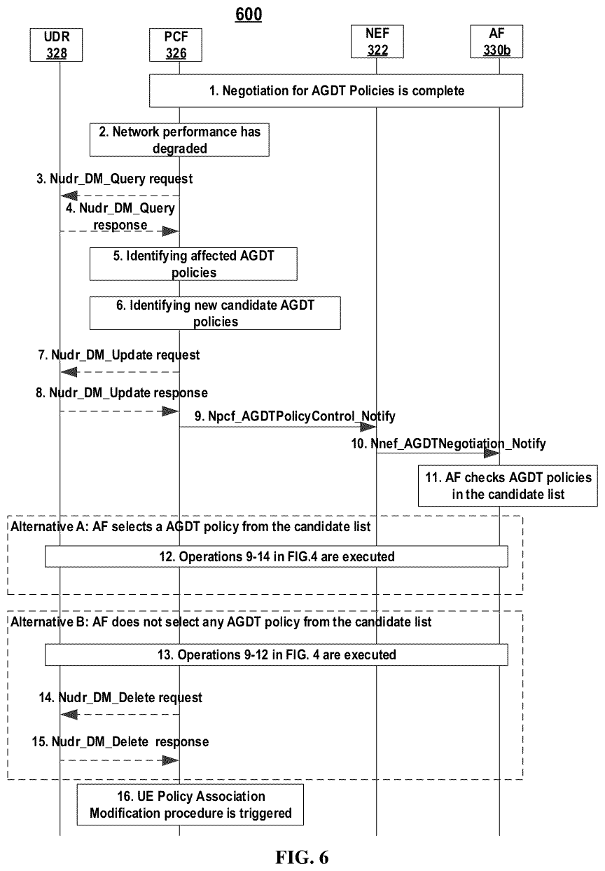

FIG. 6 illustrates a conceptual flow diagram 600 of an exemplary AGDT warning notification procedure, according to some embodiments of the present disclosure.

The operations shown in FIG. 6 may begin once the AGDT policy negotiation described above in connection with FIG. 4 is completed (at operation 1). In addition, PCF 326 has subscribed to analytics on network performance or DN performance from NWDAF (e.g., NWDAF 352 in FIG. 4) for the area of interest and time window of an AGDT policy in accordance with various techniques, which may include a reporting threshold in the analytics reporting information, as described above in detail. The value for reporting threshold may be set by PCF 326 based on operator configuration.

PCF 326 may be notified (at operation 2) with the network performance or DN performance analytics in the area of interest from the NWDAF when the NWDAF determines that the network performance goes below the threshold in accordance with the network performance analytics.

PCF 326 may request from UDR 328 the stored AGDT policies using the Nudr_DM_Query (e.g., including Policy Data, AGDT ID, etc.) service operation. Then, UDR 328 may provide (at operation 4) all the AGDT policies together with the relevant information received from AF 330b to PCF 326.

PCF 326 may identify (at operation 5) the AGDT policies affected by the notification received from the NWDAF. For the AGDT policies, PCF 326 may determine the ASP of which the AGDT traffic will be influenced by the degradation of network performance and the PCF 326 to which the notification will be sent. PCF 326 may perform the following operations for each of the determined ASPs. In other words, operations 6 through 16 may occur multiple times on for each ASP.

PCF 326 may decide (at operation 6), based on operator and/or ASP policies, whether a new list of candidate AGDT policies can be calculated for the ASP. If no new candidate AGDT policies are found, the previously negotiated AGDT policy may be kept. In this case, no interaction with AF 330b may occur, and the procedure stops for that AGDT policy. The AGDT policies of an AF that did not request to be notified are kept, and no interaction with this AF occurs.

In some embodiments, PCF 326 sets the no longer valid AGDT policy in UDR 328 as invalidated by invoking the the Nudr_DM_Update (e.g., AGDT reference ID, invalidation flag) service operation. The AGDT policies that are applicable for future sessions may be checked by PCF 326 (at operation 6). UDR 328 may send (at operation 8) a response to PCF 326 as acknowledgment.

PCF 326 may send (at operation 9) the notification to NEF 322 by invoking the Npcf_AGDTPolicyControl_Notify service operation, which may include an AGDT reference ID and a list of candidate AGDT policies.

In response, NEF 322 may send (at operation 10) the AGDT warning notification to AF 330b by invoking the Nnef_AGDTNegotiation_Notify service operation (e.g., including the AGDT reference ID and the list of candidate AGDT policies).

AF 330b may check (at operation 11) the new AGDT policies included in the candidate list in the AGDT warning notification.

In Alternative A, if AF 330b selects any of the new AGDT policies from the candidate list, operations 9-14 described above in connection with FIG. 4 may be executed (at operation 12).

In Alternative B, if the AF 330b does not select any of the new AGDT policies from the candidate list, operations 9-12 described above in connection with FIG. 4 may be executed (at operation 13), with AF 330b indicating that none of the candidate AGDT policies is acceptable. If operation 13 is executed, PCF 326 may remove the no longer valid AGDT policy from UDR 328 for the corresponding AGDT reference ID (at operations 14 and 15). PCF 326 may also remove the no longer valid AGDT policy after an operator configurable time for the case that the AF 330b does not respond.

If there is a new AGDT policy stored in UDR 328 or an AGDT policy was removed from UDR 328, PCF 326 may be notified by UDR 328 accordingly. PCF 326 may check if the corresponding UE route selection policy (URSP) rules need to be updated or removed and if so, trigger (at operation 16) the UE policy association modification procedure to update URSP rules for the relevant UEs.

In some embodiments, AF 330b sends a stop notification by invoking the Nnef_AGDTNegotiation_Update service operation, when AF 330b requests not to receive the AGDT warning notification anymore. Then, NEF 322 may invoke the Npcf_AGDTPolicyControl_Update service operation in order to provide this information to PCF 326.

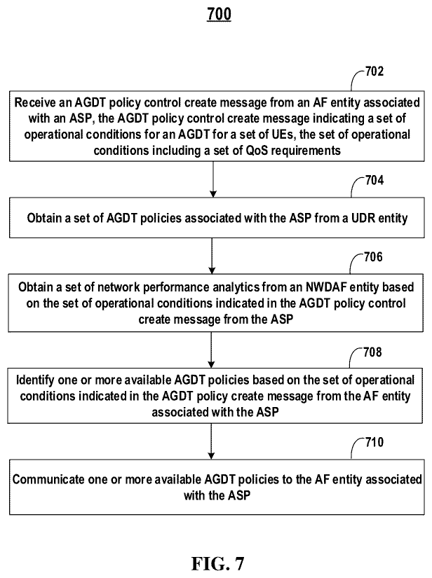

FIG. 7 illustrates a flow chart of a first exemplary method 700 of wireless communication, according to some embodiments of the present disclosure. Method 700 may be performed by PCF 326 having processor 202, memory 204, and communication interface 206. Method 700 may implement the AGDT transfer policies negotiation procedure described above in FIG. 4. It is understood that some of the operations may be optional, and some of the operations may be performed simultaneously, or in a different order other than shown in FIG. 7.

At operation 702, an AGDT policy control create message triggered by an AF entity associated with an ASP is received. In some embodiments, the AGDT policy control create message is received from the AF entity associated with the ASP. In some embodiments, the AGDT policy control create message is received from an NEF entity serving the AF entity associated with the ASP. The AGDT policy control create message may indicate a set of operational conditions for an AGDT for a set of UEs, and the set of operational conditions may include a set of QoS requirements. In some embodiments, the set of operational conditions further includes at least one of an ASP identifier, a number of UEs associated with the AGDT, a list of desired time windows for the AGDT, a list identifying the UEs for the AGDT, a set of alternative QoS parameters, an area of interest (AOI) for the AGDT, or a request for notification related to a selected AGDT policy no longer being available due to a change in network conditions prior to a start of the selected AGDT policy.

For example, communication interface 206 of PCF 326 may receive the Npcf_AGDTPolicyControl_Create Request triggered by AF 330b with or without the authentication/authorization performed by NEF 322. In one example, the Npcf_AGDTPolicyControl_Create Request may be received from NEF 322 serving AF 330b after successful authentication/authorization, as shown in FIG. 4. In another example, the Npcf_AGDTPolicyControl_Create Request may be received from AF 330a directly.

At operation 704, a set of AGDT policies associated with the ASP is obtained from a UDR entity. For example, processor 202 of PCF 326 may obtain a set of AGDT policies associated with the ASP from UDR 328 using the Nudr_DM_Query Request and Nudr_DM_Query Response, as shown in FIG. 4.

At operation 706, a set of network performance analytics is obtained from a NWDAF entity based on the set of operational conditions indicated in the AGDT policy control create message. For example, processor 202 of PCF 326 may obtain network performance analytics (e.g., network performance analytics or DN performance analytics) from NWDAF 352 based on the information included in the Npcf_AGDTPolicyControl_Create Request, as shown in FIG. 4.

At operation 708, one or more available AGDT policies are identified from the set of AGDT policies based on the set of operational conditions and the set of network performance analytics. For example, processor 202 of PCF 326 may determine the available AGDT policies from all the AGDT policies obtained from UDR 328 based on the network performance analytics from NWDAF 352 and the information included in the Npcf_AGDTPolicyControl_Create Request.

At operation 710, the one or more available AGDT policies are communicated to the AF entity associated with the ASP. For example, communication interface 206 of PCF 326 may send the determined AGDT policies to AF 330b using the Npcf_AGDTPolicyControl_Create Response, as shown in FIG. 4.

In some embodiments, in response to the change in network conditions once an AGDT policy was selected by the AF entity and the request for notification being included in the set of operational conditions, an indication that the AGDT policy is no longer valid is sent.

In some embodiments, in response to the one or more available AGDT policies including a plurality of AGDT policies communicated to the AF entity associated with the ASP, an indication of which of the plurality of AGDT policies was selected by the AF entity associated with the ASP is received. In some embodiments, a request for a revision to the AGDT policy selected by the AF entity associated with the ASP is received.

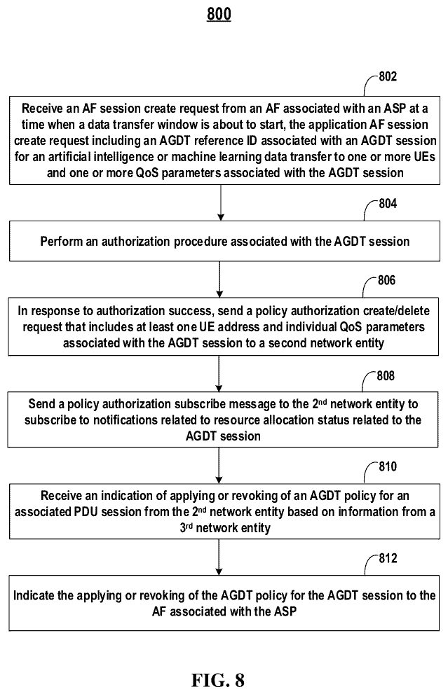

FIG. 8 illustrates a flow chart of a second exemplary method 800 of wireless communication, according to some embodiments of the present disclosure. Method 800 may be performed by PCF 326 or NEF 322 each having processor 202, memory 204, and communication interface 206. Method 800 may implement the AGDT policy applying/removing procedure described above in FIG. 5. It is understood that some of the operations may be optional, and some of the operations may be performed simultaneously, or in a different order other than shown in FIG. 8.

At operation 802, an AF session create request is received from an AF associated with an ASP at a time when a data transfer window is about to start. The AF session create request may include an AGDT reference ID associated with an AGDT session for an AI or ML data transfer to one or more UEs and one or more QoS parameters associated with the AGDT session. The data transfer window may be a planned data transfer window for the application AI/ML data. For example, communication interface 206 of NEF 322 may receive the Nnef_AFSessionWithQoS_Create Request from AF 330b including an AGDT reference ID and QoS parameters, as shown in FIG. 5. It is understood that in some examples, communication interface 206 of PCF 326 may receive the Nnef_AFSessionWithQoS_Create Request from AF 330a directly.

At operation 804, an authorization procedure associated with the AGDT session is performed. For example, processor 202 of NEF 322 may perform the authorization of the Nnef_AFSessionWithQoS_Create Request from AF 330b, as shown in FIG. 5.

At operation 806, in response to authorization success, a policy authorization create/delete request that includes at least one UE address and individual QoS parameters associated with the AGDT session is sent to a second network entity. For example, if the authorization is successful, communication interface 206 of NEF 322 may send the Npcf_PolicyAuthorization_Create/Delete Request to PCF 326, which includes a UE address and individual QoS parameters, as shown in FIG. 5.

At operation 808, a policy authorization subscribe message is sent to the second network entity to subscribe to notifications related to resource allocation status related to the AGDT session. In some embodiments, the second network entity is a PCF entity. For example, communication interface 206 of NEF 322 may send the Npcf_PolicyAuthorization_Subscribe to PCF 326 to subscribe to notifications related to resource allocation status related to the AGDT session, as shown in FIG. 5.

At operation 810, an indication of applying or revoking of an AGDT policy for an associated PDU session is received from the second network entity based on information from a third network entity. In some embodiments, the third network entity is a UDR entity. For example, communication interface 206 of NEF 322 may receive the Npcf_PolicyAuthorization_Create/Delete Response from PCF 326 based on the information from UDR 328, as shown in FIG. 5.

At operation 812, the applying or revoking of the AGDT policy for the AGDT session is indicated to the AF associated with the ASP. For example, processor 202 of NEF 322 may indicate the applying or revolving of the AGDT policy to AF 330b by sending the Nnef_AFSession WithQoS_Create/Revoke Response, as shown in FIG. 5.

In some embodiments, an AF revoke request is received from the AF associated with the ASP. In some embodiments, a revocation of the AGDT session is authorized. In some embodiments, the PDU session associated with the AGDT session is removed when the AF session is revoked.

According to one aspect of the present disclosure, a method of wireless communication of a policy control function (PCF) entity is provided. The method may include receiving, by a communication interface, an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements. The method may include, obtaining, by at least one processor, a set of AGDT policies associated with the ASP from a unified data repository (UDR) entity. The method may include obtaining, by the at least one processor, a set of network performance analytics from a network data function analytics (NWDAF) entity based on the set of operational conditions indicated in the AGDT policy control create message from the ASP. The method may include identifying, by the at least one processor, one or more available AGDT policies from the set of AGDT policies based on the set of operational conditions and the set of network performance analytics. The method may include communicating, by the at least one processor, one or more available AGDT policies to the AF entity associated with the ASP.

In some embodiments, the AGDT policy control create message is received from the AF entity associated with the ASP.

In some embodiments, the AGDT policy control create message is received from a network exposure function (NEF) entity serving the AF entity associated with the ASP.

In some embodiments, the set of operational conditions further includes at least one of an ASP identifier, a number of UEs associated with the AGDT, a list of desired time windows for the AGDT, a list identifying the UEs for the AGDT, a set of alternative QoS parameters, an area of interest (AOI) for the AGDT, or a request for notification related to a selected AGDT policy no longer being available due to a change in network conditions prior to a start of the selected AGDT policy.

In some embodiments, the method may include, in response to the change in network conditions once an AGDT policy was selected by the AF entity and the request for notification being included in the set of operational conditions, sending, by the communication interface, an indication that the AGDT policy is no longer valid.

In some embodiments, the method may include, in response to the one or more available AGDT policies including a plurality of AGDT policies communicated to the AF entity associated with the ASP, receiving, by the communication interface, an indication of which of the plurality of AGDT policies was selected by the AF entity associated with the ASP.

In some embodiments, the method may include receiving, by the communication interface, a request for a revision to the AGDT policy selected by the AF entity associated with the ASP.

According to another aspect of the present disclosure, an apparatus for wireless communication of a PCF is provided. The apparatus may include at least one processor. The apparatus may include memory having instructions stored thereon, which when executed by the at least one processor cause the at least one processor to perform receiving an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service QoS requirements. The apparatus may include memory having instructions stored thereon, which when executed by the at least one processor cause the at least one processor to perform, obtaining a set of AGDT policies associated with the ASP from a unified data repository (UDR) entity. The apparatus may include memory having instructions stored thereon, which when executed by the at least one processor cause the at least one processor to perform obtaining a set of network performance analytics from a network data function analytics (NWDAF) entity based on the set of operational conditions indicated in the AGDT policy control create message from the ASP. The apparatus may include memory having instructions stored thereon, which when executed by the at least one processor cause the at least one processor to perform identifying one or more available AGDT policies from the set of AGDT policies based on the set of operational conditions and the set of network performance analytics. The apparatus may include memory having instructions stored thereon, which when executed by the at least one processor cause the at least one processor to perform communicating one or more available AGDT policies to the AF entity associated with the ASP.

In some embodiments, the AGDT policy control create message is received from the AF entity associated with the ASP.

In some embodiments, the AGDT policy control create message is received from a network exposure function (NEF) entity serving the AF entity associated with the ASP.

In some embodiments, the set of operational conditions further includes at least one of an ASP identifier, a number of UEs associated with the AGDT, a list of desired time windows for the AGDT, a list identifying the UEs for the AGDT, a set of alternative QoS parameters, an area of interest (AOI) for the AGDT, or a request for notification related to a selected AGDT policy no longer being available due to a change in network conditions prior to a start of the selected AGDT policy.

In some embodiments, the memory storing instructions, which when executed by the at least one processor, further causes the at least one processor to perform, in response to the change in network conditions once an AGDT policy was selected by the AF entity and the request for notification being included in the set of operational conditions, sending an indication that the AGDT policy is no longer valid.

In some embodiments, the memory storing instructions, which when executed by the at least one processor, further causes the at least one processor to perform, in response to the one or more available AGDT policies including a plurality of AGDT policies communicated to the AF entity associated with the ASP, receiving an indication of which of the plurality of AGDT policies was selected by the AF entity associated with the ASP.

In some embodiments, the memory storing instructions, which when executed by the at least one processor, further causes the at least one processor to perform receiving a request for a revision to the selected AGDT policy after a selection of the selected AGDT policy.

According to still another aspect of the present disclosure, a method of wireless communication of a first network element is provided. The method may include receiving, by a communication interface, an application function (AF) session create request from an AF associated with an application service provider (ASP) at a time when a data transfer window is about to start, the AF session create request including an application group data transfer (AGDT) reference identifier (ID) associated with an AGDT session for an artificial intelligence or machine learning data transfer to one or more user equipments (UEs) and one or more quality-of-service (QOS) parameters associated with the AGDT session. The method may include performing, by at least one processor, an authorization procedure associated with the AGDT session. The method may include, in response to authorization success, sending, by the communication interface, a policy authorization create request that includes at least one user equipment (UE) address and individual quality-of-service (QOS) parameters associated with the AGDT session to a second network entity. The method may include sending, by the communication interface, a policy authorization subscribe message to the second network entity to subscribe to notifications related to resource allocation status related to the AGDT session. The method may include receiving, by the communication interface, an indication of applying of an AGDT policy for an associated protocol data unit (PDU) session from the second network entity based on information from a third network entity. The method may include indicating, by the at least one processor, the applying of the AGDT policy for the AGDT session to the AF associated with the ASP.

In some embodiments, the first network entity is a network exposure function (NEF) entity, and the second network entity is a policy control function (PCF) entity.

In some embodiments, the method may include receiving, by the communication interface, an AF revoke request from the AF associated with the ASP. In some embodiments, the method may include authorizing, by at least one processor, a revocation of the AGDT session.

In some embodiments, the method may include removing, by the at least one processor, the PDU session associated with the AGDT session when the AF session is revoked. In some embodiments, the first network entity is a policy control function (PCF) entity, or the first network entity is a network exposure function (NEF) entity, the second network entity is a policy control function (PCF) entity, and the third network entity is a unified data repository (UDR) entity.

According to still another aspect of the present disclosure, a method of wireless communication of a first network element is provided. The method may include receiving, by a communication interface, an application function (AF) session create request from an AF associated with an application service provider (ASP) at a time when a data transfer window is about to start, the application AF session create request including an application group data transfer (AGDT) reference identifier (ID) associated with an AGDT session for an artificial intelligence or machine learning data transfer to one or more user equipments (UEs) and one or more quality-of-service (QOS) parameters associated with the AGDT session. The method may include performing, by at least one processor, an authorization procedure associated with the AGDT session. The method may include, in response to authorization success, sending, by the communication interface, a policy authorization delete request that includes at least one user equipment (UE) address and individual quality-of-service (QOS) parameters associated with the AGDT session to a second network entity. The method may include sending, by the communication interface, a policy authorization subscribe message to the second network entity to subscribe to notifications related to resource allocation status related to the AGDT session. The method may include receiving, by the communication interface, an indication of revoking of an AGDT policy for an associated protocol data unit (PDU) session from the second network entity based on information from a third network entity. The method may include indicating, by the at least one processor, the revoking of the AGDT policy for the AGDT session to the AF associated with the ASP.

In some embodiments, the first network entity is a network exposure function (NEF) entity, and the second network entity is a policy control function (PCF) entity.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of wireless communication of a policy control function (PCF) entity, comprising:
receiving, by a communication interface, an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements;
obtaining, by at least one processor, a set of AGDT policies associated with the ASP from a unified data repository (UDR) entity;
obtaining, by the at least one processor, a set of network performance analytics from a network data function analytics (NWDAF) entity based on the set of operational conditions indicated in the AGDT policy control create message;
identifying, by the at least one processor, one or more available AGDT policies from the set of AGDT policies based on the set of operational conditions and the set of network performance analytics; and
communicating, by the at least one processor, the one or more available AGDT policies to the AF entity associated with the ASP.

2. The method of claim 1, wherein the AGDT policy control create message is received from the AF entity associated with the ASP.

3. The method of claim 1, wherein the AGDT policy control create message is received from a network exposure function (NEF) entity serving the AF entity associated with the ASP.

4. The method of claim 1, wherein the set of operational conditions further includes at least one of an ASP identifier, a number of UEs associated with the AGDT, a list of desired time windows for the AGDT, a list identifying the UEs for the AGDT, a set of alternative QoS parameters, an area of interest (AOI) for the AGDT, or a request for notification related to a selected AGDT policy no longer being available due to a change in network conditions prior to a start of the selected AGDT policy.

5. The method of claim 4, further comprising:
in response to the change in network conditions once an AGDT policy was selected by the AF entity, and the request for notification being included in the set of operational conditions, sending, by the communication interface, an indication that the AGDT policy is no longer valid.

6. The method of claim 1, further comprising:
in response to the one or more available AGDT policies including a plurality of AGDT policies communicated to the AF entity associated with the ASP, receiving, by the communication interface, an indication of which of the plurality of AGDT policies was selected by the AF entity associated with the ASP.

7. The method of claim 6, further comprising:
receiving, by the communication interface, a request for a revision to the AGDT policy selected by the AF entity associated with the ASP.

8. An apparatus for wireless communication of a policy control function (PCF) entity, comprising:
at least one processor;
memory storing instructions, which when executed by the at least one processor, cause the at least one processor to perform:
receiving an application group data transfer (AGDT) policy control create message triggered by an application function (AF) entity associated with an application service provider (ASP), the AGDT policy control create message indicating a set of operational conditions for an AGDT for a set of user equipments (UEs), the set of operational conditions including a set of quality-of-service (QOS) requirements;
obtaining a set of AGDT policies associated with the ASP from a unified data repository (UDR) entity;
obtaining a set of network performance analytics from a network data function analytics (NWDAF) entity based on the set of operational conditions indicated in the AGDT policy control create message;
identifying one or more available AGDT policies from the set of AGDT policies based on the set of operational conditions and the set of network performance analytics; and
communicating the one or more available AGDT policies to the AF entity associated with the ASP.

9. The apparatus of claim 8, wherein the AGDT policy control create message is received from the AF entity associated with the ASP.

10. The apparatus of claim 8, wherein the AGDT policy control create message is received from a network exposure function (NEF) entity serving the AF entity associated with the ASP.

11. The apparatus of claim 8, wherein the set of operational conditions further includes at least one of an ASP identifier, a number of UEs associated with the AGDT, a list of desired time windows for the AGDT, a list identifying the UEs for the AGDT, a set of alternative QoS parameters, an area of interest (AOI) for the AGDT, or a request for notification related to a selected AGDT policy no longer being available due to a change in network conditions prior to a start of the selected AGDT policy.

12. The apparatus of claim 11, wherein the memory storing instructions, which when executed by the at least one processor, further causes the at least one processor to perform:
in response to the change in network conditions once an AGDT policy was selected by the AF entity, and the request for notification being included in the set of operational conditions, sending an indication that the AGDT policy is no longer valid.

13. The apparatus of claim 8, wherein the memory storing instructions, which when executed by the at least one processor, further causes the at least one processor to perform:
in response to the one or more available AGDT policies including a plurality of AGDT policies communicated to the AF entity associated with the ASP, receiving an indication of which of the plurality of AGDT policies was selected by the AF entity associated with the ASP.

14. The apparatus of claim 13, wherein the memory storing instructions, which when executed by the at least one processor, further causes the at least one processor to perform:
receiving a request for a revision to the selected AGDT policy after a selection of the selected AGDT policy.

15. A method of wireless communication of a first network entity, comprising:
receiving, by a communication interface, an application function (AF) session create request from an AF associated with an application service provider (ASP) at a time when a data transfer window is about to start, the AF session create request including an application group data transfer (AGDT) reference identifier (ID) associated with an AGDT session for an artificial intelligence or machine learning data transfer to one or more user equipments (UEs) and one or more quality-of-service (QOS) parameters associated with the AGDT session;
performing, by at least one processor, an authorization procedure associated with the AGDT session;
in response to authorization success, sending, by the communication interface, a policy authorization create request that includes at least one UE address and individual QoS parameters associated with the AGDT session to a second network entity;
sending, by the communication interface, a policy authorization subscribe message to the second network entity to subscribe to notifications related to resource allocation status related to the AGDT session;
receiving, by the communication interface, an indication of applying of an AGDT policy for an associated protocol data unit (PDU) session from the second network entity based on information from a third network entity; and
indicating, by the at least one processor, the applying of the AGDT policy for the AGDT session to the AF associated with the ASP.

16. The method of claim 15, wherein the first network entity is a network exposure function (NEF) entity, and the second network entity is a policy control function (PCF) entity.

17. The method of claim 15, further comprising:
receiving, by the communication interface, an AF revoke request from the AF associated with the ASP; and
authorizing, by the at least one processor, a revocation of the AGDT session.

18. The method of claim 17, further comprising:
removing, by the at least one processor, the PDU session associated with the AGDT session when the AF session is revoked, and
wherein the first network entity is a policy control function (PCF) entity, or
wherein the first network entity is a network exposure function (NEF) entity, the second network entity is a policy control function (PCF) entity, and the third network entity is a unified data repository (UDR) entity.

19. The method of claim 15, wherein the indication of applying of the AGDT policy for the associated PDU session is received from a response of the policy authorization create request from the second network entity.

20. The method of claim 15, wherein indicating, by the at least one processor, the applying of the AGDT policy for the AGDT session to the AF associated with the ASP comprises:
sending, by the at least one processor, a response of the AF session create request to the AF associated with the ASP to indicate the applying of the AGDT policy for the AGDT session.
